(19) United States
(12) Patent Application Publication
(10) Pub. No.: US 2020/0226540 A1
(43) Pub. Date: Jul. 16, 2020

(54) DISTRIBUTED CRYPTOGRAPHIC INVENTORY DATA COLLECTION, STORAGE AND PROCESSING SYSTEM

(71) Applicant: Omnicounts, LLC, Dallas, TX (US)

(72) Inventor: Christopher Carter Graves, Dallas, TX (US)

(73) Assignee: Omnicounts, LLC, Dallas, TX (US)

(21) Appl. No.: 16/737,726

(22) Filed: Jan. 8, 2020

Related U.S. Application Data
(60) Provisional application No. 62/789,747, filed on Jan. 8, 2019.

(51) Int. Cl. G06Q 10/08; H04L 9/06

(52) U.S. Cl. CPC G06Q 10/087; H04L 9/0637; H04L 9/0643

(57) ABSTRACT

A cryptographically enforced ordering and hierarchical ledger for the distributed collection and processing of inventory data across multiple locations, areas and items is provided.

### CROSS-REFERENCE TO RELATED APPLICATIONS

This application claims priority benefit from U.S. Provisional Application No. 62/789,747, filed on Jan. 8, 2019. The patent application identified above is incorporated here by reference in its entirety to provide continuity of disclosure.

### FIELD OF THE INVENTION

The technical field of the invention is related to inventory management and tracking systems which preserve details of how inventories are taken of retail store goods.

### BACKGROUND OF THE INVENTION

Inventory counts of goods in retail locations can be time consuming and error prone. For example, referring to FIG. 1, a chain of retail stores may have many locations. In the figure this can be represented by location 1, location 2 and location 3. Each of the locations is responsible for reporting inventory to an administrator. The administrator in turn reports to an auditor.

Each location during an inventory count “freezes” operations for a predetermined period of time. During this time, inventory takers, represented in the figure by persons 1-6 are responsible for counting items in each location.

Each location can have different types of retail goods located in different areas of each location. This is represented in the figure by departments 1-12. In this figure, each inventory taker is responsible for counting the items in two separate departments. Each of the departments can have different types of items and different numbers of items. In the figure, these are represented by items 1-12.

Referring to FIG. 2, the inventory takers are responsible for reporting final counts of each item at each location. In this example, the count for item 1 is four (4) at location 1, three (3) at location 2 and two (2) at location 3. The count for item 2 is five (5) at location 1, six (6) at location 2 and seven (7) at location 3. The item count for item 3 is eight (8) at location 1, nine (9) at location 2 and ten (10) at location 3. The item count for item 4 is one (1) at location 1, zero (0) at location 2 and one (1) at location 3. During the inventory count the totals for each item, here item 1, nine (9); item 2, eighteen (18); item 3, twenty-seven (27); and item 4, two (2), are reported directly to the administrator. The administrator, in turn, is responsible for reporting to an auditor who certifies the counts of the various items for the inventory process.

One of the main problems with the prior art inventory counting methods and systems is that traceability of who took the count, when the count was taken and where the count was taken are lost in the reporting process. For example, existing inventory systems generally require several handheld scanners that are wirelessly connected to a base unit. An example, is the SD62 wireless base station by Honeywell International Inc. When an inventory count is done, the handheld units are capable of only reading bar codes and inventory “counts” of various inventory items. In reporting final counts, the units are technically incapable of organizing or encrypting data related to the inventory count. This is a technical problem because data related where the items are located and when the item count was taken is lost in the final count total. In this example, the administrator may report that there are twenty-seven (27) of item 3 existing in inventory. However, upon audit, the total number may be different. Neither the administrator nor the auditor can determine which location is short from the total amount reported. Similarly, neither the administrator nor the auditor can determine when the error occurred, or which inventory taker was responsible for the error.

In order for an audit to be complete, traceability is required. For adequate traceability, it is necessary to be certain of the:
order of collection of transactions within locations;
order of processing of transactions into the total counts;
that none of the transactions have been tampered with;
that none of the transactions are missing;
that all the transactions took place within a fixed timeframe; and,
ability to verify and reproduce inventory subtotals, inventory taken, identity and item location details.

The prior art has provided various attempts to solve some of the problems of inventory tracking, with limited success.

U.S. Pat. No. 10,474,938 to Pigott, et al. discloses a system for cataloging items that are tagged with a unique identifier. The tag can be interrogated in order to accomplish an inventory count, by a number of different tag interrogators. Information from the interrogators is then recorded in a blockchain ledger which includes the interrogation transactions. A computationally disadvantageous agreement between many nodes is required for the Pigott system.

In “A UAV and Blockchain Based System for Industry 4.0 Inventory and Traceability Applications”, by Fernández-Caramés discloses use of unmanned aerial vehicle to automate inventory in a warehouse environment. Inventory data from the UAV is incorporated into a blockchain to ensure trustworthiness.

China Publication No. CN 110503362A to Zhao, discloses a warehouse inventory management system using RFID read write devices to perform an inventory and store the results in a traceability center. Inventory results such as start time, end time, video number and video hash code are included in a blockchain certificate to ensure trustworthiness. Theoretical inventory, actual inventory, abnormal inventory and normal inventory can be included in the inventory data.

U. S. Publication No. 2018/0144292 to Mattingly, et al. discloses a system which detects changes in inventory (like food) in a retail location and then records those changes in a blockchain.

However, as can be seen, the prior art does not provide for a traceability system which include details of how the inventory was taken nor does it provide for trustworthiness of this detailed data without the requirement of a computational agreement between multiple computational nodes.

### SUMMARY OF THE INVENTION

The preferred method of cryptographically enforced ordering is through a chained distributed set of cryptographically hashed transactions. Each set of hashed transactions is referred to a block. Each transaction is linked to the prior transaction hash and the parent transaction hash. Each block contains a cryptographic hash of the previous block, a time stamp, and transaction data.

Chaining of each of the blocks can occur in three ways, a “split”, a “direct inherit” and “join” transaction.

The cryptographic hash can be a symmetric or asymmetric cypher. Each type of cypher provides a single unique and repeatable result for each unique string of input data. In the case of an asymmetric cypher, such as RSA or DES, a public/private key pair is used to encode and decode information from each of the blocks. In the case of a symmetric cypher, such as a fractal cypher, the inherent strength of the cryptographic encoding is stronger. For a symmetric cypher, a single seed key is required to encode and then decode information in each of the blocks.

In a preferred embodiment, the hash function is SHA256. The SHA256 hash has the capability of encrypting any number of bytes into a unique string of 256 bytes. The SHA256 hash is also useful because the likelihood of a collision resulting in 2 data strings with the same hash value is very (very) low.

In another embodiment, the hash function used can rotate between different hash functions for each successive block in the transaction chain. The predetermined hash rotation order is simply reversed during the verification process.

The final chained set of cryptographically hashed transactions is resistant to modification because it can record transactions between two or more parties efficiently in a verifiable and permanent way. Once recorded, the data at any given block cannot be altered retroactively without alteration of all subsequent blocks.

This chain of transactions permits decentralized processing which increases security and efficiency of the computing system without having the disadvantage of requiring many separate computational nodes to agree on legitimacy of a block before it is added to the chain. Further, chained transaction records are considered computationally secure and exemplify a distributed computing system with a high byzantine fault tolerance.

Tallying of results can be distributed and collected with verifiable assurance of the ordering and completeness of transactions.

The ordering of transactions collected within blocks and the order of subtotaling is preserved and verifiable by a third party.

Auditors armed with genesis and apocalypse block addresses can be certain that the ledger of transactions is unaltered and in original order of processing.

Inventory totaling process can be certain that no transactions were omitted.

Auditors or other third parties can be certain no transactions took place before generation of the genesis block or after communication of the apocalypse block.

Transactions may be collected at a central processing location in any order and at any time while preserving the ability to reproduce the entire counting process in the order it was collected and processed.

### BRIEF DESCRIPTION OF THE DRAWINGS

In the detailed description of the preferred embodiments presented below, reference is made to the accompanying drawings.

FIG. 1 is a schematic diagram of an invention collection system of the prior art.

FIG. 2 is an example of an inventory tally sheet of the prior art.

FIG. 3 is a schematic diagram of a preferred embodiment.

FIG. 4A is a schematic diagram of an example chained transaction record.

FIG. 4B is a flowchart of a method to create a chained transaction record.

FIGS. 5A and 5B are a network flow diagram of a preferred embodiment.

FIGS. 6A and 6B are a schematic diagram of an example chained transaction record.

FIG. 7 is a flowchart of a method of transaction chain verification.

FIGS. 8A and 8B are a flowchart of an alternate method of transaction chain verification.

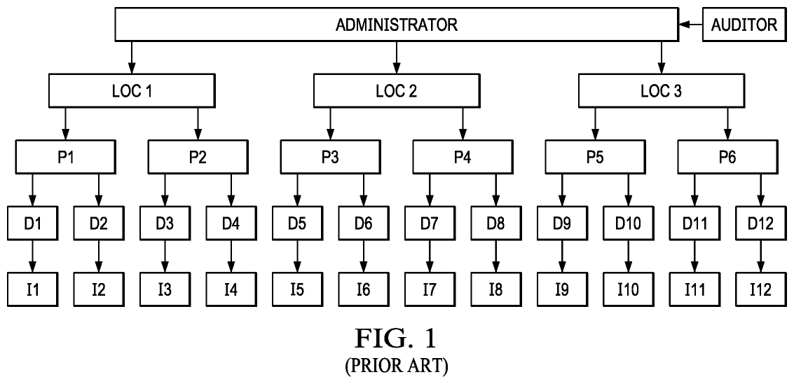

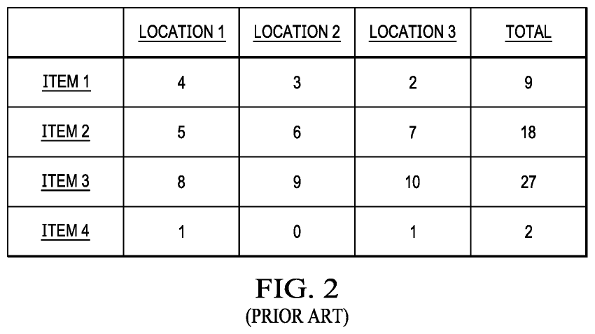

### DETAILED DESCRIPTION OF THE INVENTION

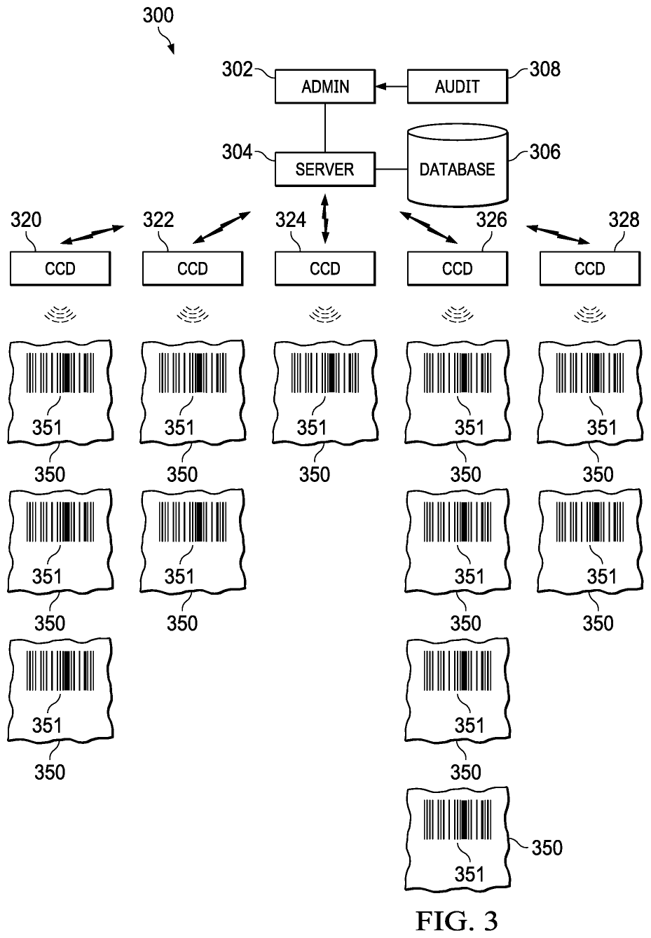

Referring to FIG. 3, exemplary architecture diagram 300 of a preferred embodiment will be described. Administrator device 302 is connected through a wide area network to audit device 308. Administrator device 302 is further connected through a local area network to server 304. Server 304 is connected to database 306.

Client counting devices 320, 322, 324, 326 and 328 are connected through a wireless network to server 304. Each of the client counting devices is fitted with an optical reader capable of reading bar codes 351 on each of items 350. Each bar code 351 includes data sufficient to identify each item 350 by description and serial number. In a preferred embodiment, each of client counting device can comprise a smartphone or dedicated optical reader such as a Zebra TC56 Touch Computer, available from Zebra Technologies Corp.

Server 304 further comprises an operating system and software capable of executing steps sufficient to carry out purposes of the invention. For example, in a preferred embodiment the server is a Dell PowerEdge T640, available from Dell Technologies, Inc. of Round Rock, Tex.

All software in the preferred embodiment is written in C, Python or C++. Of course, other languages will suffice.

In a preferred embodiment, database 306 is a SQL database programmed to respond to typical queries by server 304.

Each client counting device is responsible for generating a series of “transaction blocks” for each inventory count for a particular retail item. The transaction blocks are communicated to the server which then assembles them into a transaction table which is transmitted to the administrator. The administrator transmits the transaction table to the auditor who can use the table to verify details of the inventory count, as will be further described.

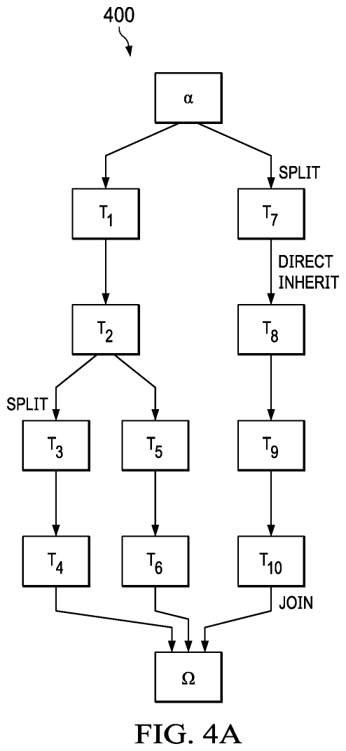

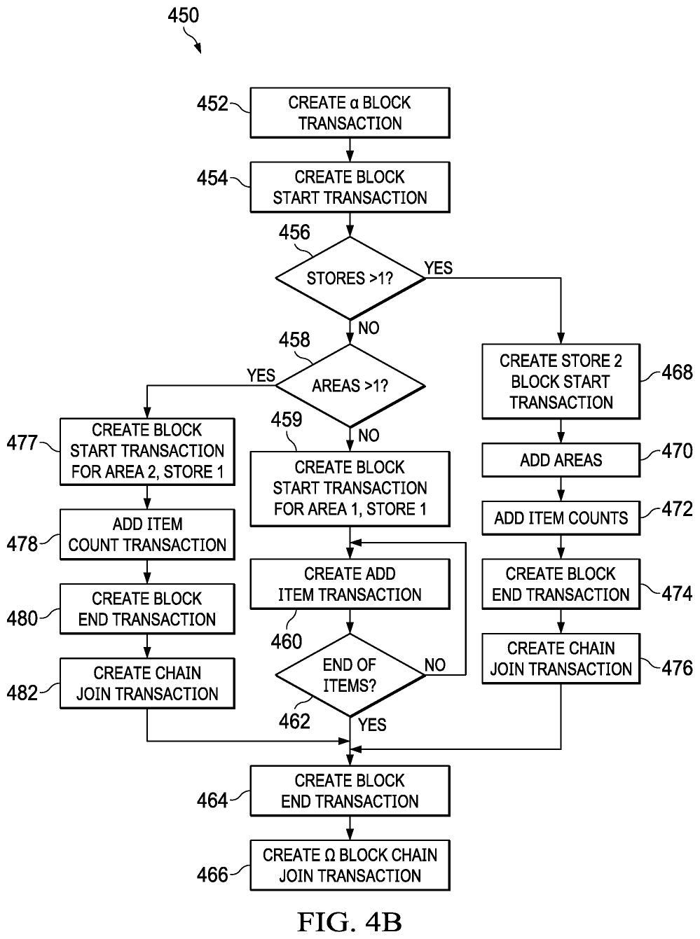

Referring to FIG. 4A, example 400 of inventory transactions assembled into an Ω block will be described. In this hierarchy example, a single store has two (2) locations. One of these locations has two (2) areas. Both locations and both areas include counts of two (2) separate types of items. However, infinite numbers of variations of hierarchies of stores, areas and items are possible and can be accommodated by the invention, applying a set of novel rules for the transaction blocks, splits and joins, as will be further described.

In this example, the initiation of an audit count, the server generates an α block which will be further described. The α block is split into two parallel transactions, T₁ and T₇ in order to account for the two separate locations. Client counting device 320 receives transaction T₁ and proceeds during the inventory count to generate transaction block T₂. The client counting device generates a split of transaction block T₂ into transaction blocks T₃ and T₅ in order to account for the two separate areas in the first store. The client counting device then generates transaction blocks T₄ and T₆ during routine counts of inventory goods.

The second client counting device receives transaction block T₇ from the server. During routine inventory counts, the second client counting device generates and records transaction blocks T₈, T₉ and T₁₀. These blocks each inherit directly from their immediate predecessor.

At the conclusion of the inventory count, transaction blocks T₄, T₆ and T₁₀ are sent to the server where they are joined into the Ω transaction block. The Ω transaction block and a transaction table are then communicated to the auditor. Because every transaction (except the α block) contains the address of its parent and the address of its prior transaction, it is not possible to alter a transaction's contents or to trace from a block end to a block start if transactions are missing or altered.

The transaction blocks exhibit conform to the following rules and exhibit the following attributes:

An “address” is a data string resulting from a known hash of an ordered set of parameters.

α=Genesis Address—The beginning address and parent of all count data. The Genesis Address can be public blockchain address/transaction/hash or some other seed that matches a predetermined hash length and which can be fixed in time. For instance, β the latest Bitcoin block hash.

Ω=Apocalypse Address—The final transaction block address which once communicated to a third party, all can be assured no transactions can be subsequently modified, added, or removed within the chain.

f_{#}=A cryptographic hash function (SHA256 for example)

A=Block address (the result of cryptographic hash function)

T=Transaction

Transactions contain (at minimum):
A_{pb}=Parent block address
Aₚₜ=Prior transaction address
t=Transaction Type which (at minimum) consist of:
BS=Denotes a block start transaction
BE=Denotes a block end transaction
CJ=Denotes block join transaction to parent chain
IA=Denotes an item “addition” transaction
Bₙₐₘₑ=Block Name/Identifier (any desired identifier string) (May be NULL)
Iₙₐₘₑ=Item Name/Identifier (any desired identifier string) (May be NULL)
Q=Quantity (any real number −∞ to +∞) (May be NULL).

Transactions (T) take the form:

T={A_{pb},Aₚₜ,t,Bₙₐₘₑ,Iₙₐₘₑ,Q}

Additional data can be included in the transaction, timestamps for instance.

B=Valid Block consisting of:
A block start transaction (BS) (Required)
Zero or more item transactions (IA)
Zero or more valid child blocks (B_{child})
A block end transaction (BE) (Required)
A block join transaction (BJ) (Required).

Each transaction address is the result of the hash function upon its' transaction contents.

Transaction addresses are created as follows:

Aᵢ=f_{#{}Tᵢ{A_{pb},Aₚₜ,t,Bₙₐₘₑ,Iₙₐₘₑ,Q}}

Every transaction must have a parent block address (A_{pb}) and a prior transaction address (Aₚₜ).

An α transaction is always a BS transaction.

The parent of a BS transaction is always a BS transaction

The parent of a BE transaction is always a BS transaction.

The parent of an IA transaction is always a BS transaction.

The parent of a CJ transaction is always a BE transaction.

CJ transactions are performed to the longest transaction chain within parent block.

CJ transactions must always have a BE or CJ as their prior transaction.

A Ω transaction is always a CJ transaction.

Any given transaction address (Aᵢ) must have a continuous chain of prior transaction addresses back to the α transaction address.

Any given transaction address (Aᵢ) must have a continuous chain of parent transaction addresses back to the α transaction address and from the Ω transaction address back to Aᵢ.

Additional transaction types and data payloads can be added to this fundamental list within any predetermined number blocks to provide flexibility in logging the count activities and to benefit from the immutable ordering and recording of transactions. In a preferred embodiment, the predetermined number is 3.

A chain join transaction (CJ) is used to denote that a block end (BE) transaction has been received and processed by the server. The CJ transaction has the effect of closing an open side transaction chain back to the main chain and ultimately the Ω block.

When a client sends a BE transaction it is denoting that there are no further transactions to be included in this block.

When the server creates the CJ transaction, it is indelibly tying the side chain to the main chain. If the client process or some bad actor were to subsequently create new transactions or blocks (ostensibly for inclusion in the block which it has already closed) it would not be possible to trace from the Ω block to this orphaned transaction or block and therefore it could not be included in the count.

Referring to FIG. 4B, method 450 of creating a series of inventory transactions will be described.

At step 452, an α block address transaction is created, as previously described.

At step 454, block start transaction is created, as previously described.

At step 456, a decision is made as to whether or not the number of stores is greater than one. If not, the method moves to step 458, if so the method moves to step 468.

At step 458, a decision is made as to whether or not the number of areas in the store is greater than one. If not, the method moves to step 459. If so, the method moves to step 477. At step 477, a block start transaction is created for area 2 and store 1.

At step 459, block start transaction is created for area 1, store 1.

At step 460, an add item transaction is created. At step 462, a decision is made as to whether or not all items have been counted. If not, the method returns to step 460. If so, the method moves to step 464.

At step 464, a block end transaction is created. At step 466, an Ω block is created with a chain join transaction.

Returning to step 468, if the number of stores is greater than one, then a store 2 block start transaction is created. At step 470, the additional areas are created. At step 470, if additional areas are created, block start transactions for those areas are created, as previously described.

At step 472, for each area, add item transactions are created, as previously described.

At step 474, block end transactions are created for each item count and for each area, as previously described. At step 476, a chain join transaction is created and the method returns to step 464.

Returning to step 458, if the number of areas in the store is greater than one, then at step 478, add item count transaction is created. At step 480, block end transactions are created. At step 482, chain join transactions are created and the method returns to step 464.

A simple example of a transaction chain is next described.

First, an α block address is created. α can be a random seed of defined length that was not known to any parties prior to count start. Alternatively, it can be the most recent bitcoin blockchain hash at the start of count.

Aα=f_{#}(α,α,BS,“Count1”,NULL,NULL)

Second, the address for the block start transaction representing store one is created. In this case, both the parent and prior transaction addresses are the same (alpha block).

The α block address (created above) is incorporated into the hash for the A1 address. Hence, the transactions are “linked.” Each transaction address is a hash value based on an input that includes its parent and prior transaction addresses.

A1=f_{#}(Aα,Aα,BS,“Store1”,NULL,NULL)

Next, the transaction address for the block start representing area 1 in store 1 is created.

A2=f_{#}(A1,A1,BS,“Area1”,NULL,NULL)

Next, the transaction address representing the addition of quantity 1 of item UPCXXXXXXXX to area 1 is created.

A1=f_{#}(A2,A2,IA,NULL,“UPCXXXXXXXX”,1)

Next, another item is added to the count. Note the difference in parent and prior block addresses. This is how the ledger is imbued with hierarchy.

A4=f_{#}(A2,A3,IA,NULL,“UPCYYYYYYYY”,1)

Next, the block for area 1 is ended.

A5=f_{#}(A2,A4,IA,BE,NULL,NULL)

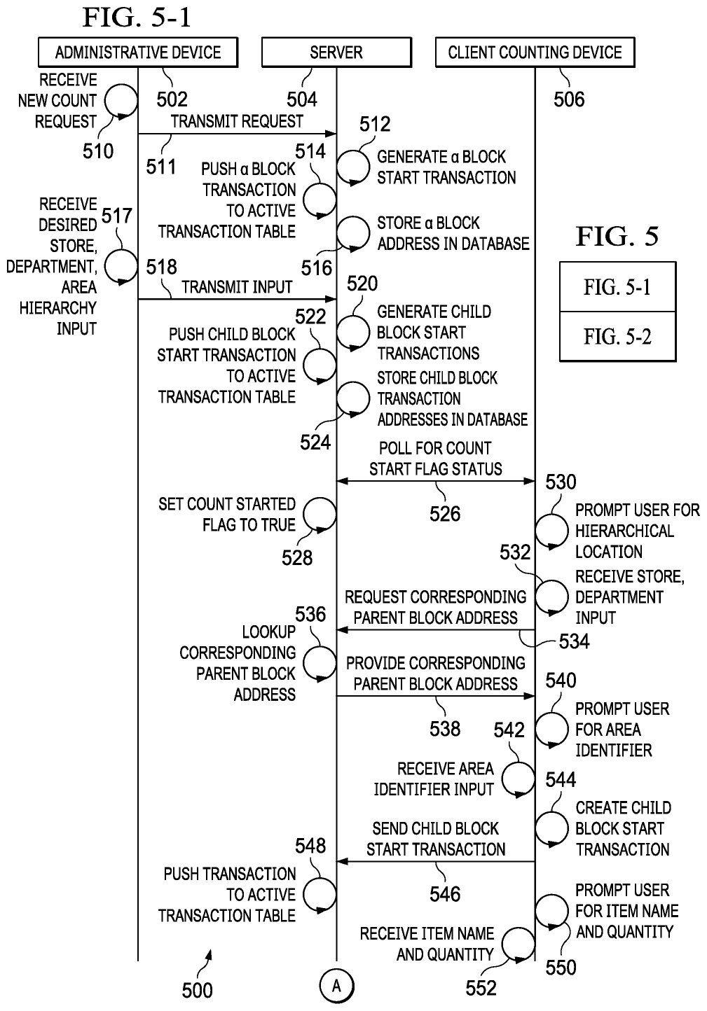

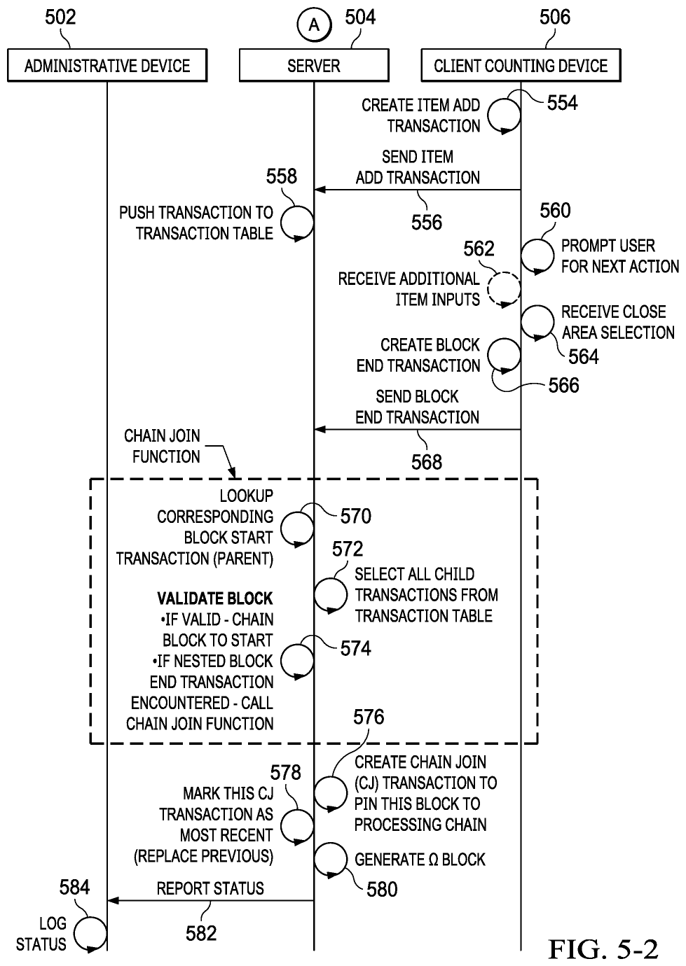

Referring to FIGS. 5A and 5B, a network communications diagram of a preferred embodiment of the system for processing inventory data is described. System 500 comprises administrative device 502, server 504 and client counting device 506.

In a preferred embodiment, administrative device 502 is a smart device or PC, and client counting device 506, is a handheld mobile computing device, such as a cellphone or a wireless handheld barcode scanner. Administrative device 502, client counting device 506, and server 504 are each connected to the internet.

Referring then to FIG. 5A, at step 510, the administrative device receives a request for a new count. In step 511, the request is transmitted to server 504. At step 512, server 504 generates an α block start transaction and creates an active transaction table in the database.

In a preferred embodiment, a single hash function is used to create all address blocks. Preferably the hash function is one of the SHA256, MD5, RIPEMD256, WHIRLPOOL, TIGER(192) and GOST(256) cyphers. However, in alternate embodiments, a rotating series of hash functions may be used. In this case, different hash functions are used in a predetermined order to encrypt successive blocks. The preferred set of rotating hashes is an ordered application of the SHA256, MD5, RIPEMD256, WHIRLPOOL, TIGER(192) and GOST(256) cyphers. Other ordered sets of these and other cyphers may be used advantageously in other embodiments.

At step 514, the server pushes the α block transaction to the active transaction table. At step 516, the server stores the α block address in the database.

In an alternate embodiment, before transmission of any block over a communications channel, it may be encrypted with either a symmetric cypher using a seed key, or an asymmetric cypher, using a public key. An example of useful symmetric cypher is a fractal cypher. An example of a useful asymmetric cypher is DES. In this embodiment, the block is decoded by the receiving node before verification by applying the appropriate seed key (for a symmetric cypher) or private key (for an asymmetric cypher).

At step 517, administrative device 502 receives the desired store, department, and area hierarchy. In step 518, the administrative device transmits the desired store, department, and area hierarchy to server 504.

At step 520, the server generates one or more child block start transactions. At step 522, the server pushes the child block start transactions to the active transaction table. In step 524, server 504 stores the child block transaction addresses in the database.

At step 526, client counting device 506 continuously polls server 504 for a count start flag status until it receives a “true” result. In step 528, server 504 will set the count started flag status to “true” upon start of the inventory freeze period. At step 530, client counting device 506 will prompt the user for the hierarchical location. In step 532, the client counting device will receive the hierarchal location input such as store and department. At this step, the identity of the inventory taker is also received.

At step 534, the client counting device transmits a request for the corresponding parent block address to the server. In step 536, server 504 will determine the corresponding parent block address. At step 538, the server transmits the corresponding parent block address to the client counting device.

At step 540, the client counting device will prompt the user for an area identifier. In step 542, the client counting device receives the area identifier.

At step 544, client counting device 506 creates a child block start transaction. At step 546, the child block start transaction is transmitted to the server. In step 548, the server pushes the transaction to the active transaction table.

At step 550, client counting device 506 prompts the user for item name and quantity input. In step 552, the client counting device receives the item name and quantity input. In a preferred embodiment, the item name and quantity can be manually entered, or a client counting device can optically scan a barcode, such as a UPC or QR code, which will auto-populate the item name and an editable quantity count of one (1).

Referring then to FIG. 5B, at step 554, the client device creates an “item add” transaction. In step 556, the item add transaction is transmitted to the server. At step 558, server 504 pushes the transaction to the transaction table.

At step 560, client counting device 506 will prompt the user for a next action. At step 562, the user may select to input a new item name and quantity. In a preferred embodiment, the available options may consist of entering an additional item name and quantity or end the count. If the client counting device receives a new item name and quantity at step 562, then the client counting device will repeat steps 554, 556, and 558 for each additional item name/quantity input until the area count is complete. At step 564, client counting device 506 receives a close area selection, which will end the area count.

At step 566, the client counting device will create a block end transaction. At step 568, the block end transaction is sent to the server.

Steps 570, 572, and 574 comprise the chain join function steps. At step 570, the server will look up the corresponding block start transaction, or parent block. At step 572, each child transaction, in turn, is selected from the transaction table. In step 574, server 504 will validate the block. If the block is valid, then the block is chained to the block start (parent block). If server 504 encounters a nested block end transaction, then it calls the chain join function to run for that specific block.

At step 576, the server creates a CJ transaction to pin the block to a processing chain. At step 578, the CJ transaction is marked as the most recent transaction replacing the previous transaction. At step 580, server 504 generates an Ω block.

At step 582, the server transmits a status report. At step 584, the administrative device logs the status.

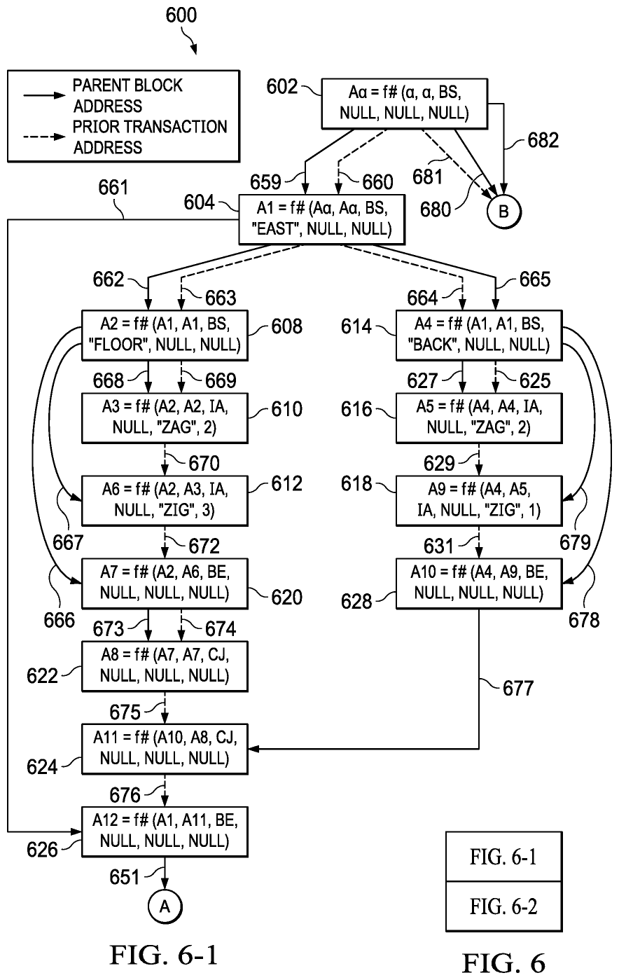

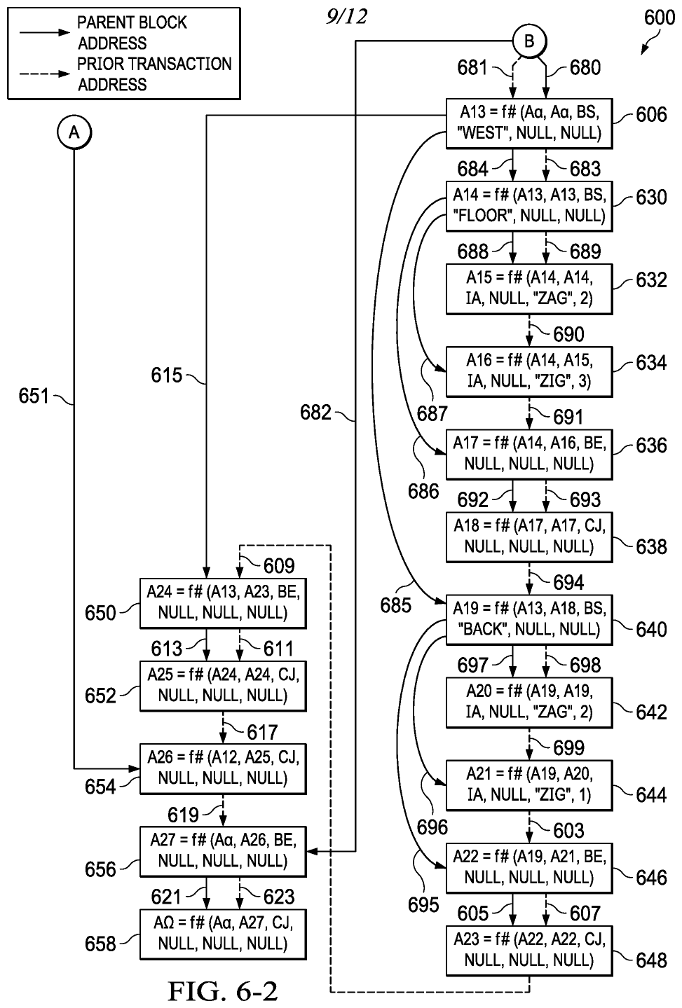

Referring to FIGS. 6A and 6B, an example ledger transaction produced by the invention during an inventory count will be described.

XYZ Widgets stocks two types of items (zigs and zags) at each of their two locations (east and west). Further, each location stocks items in either a floor or a back stock room area (floor and back). XYZ wishes to hire a third party (Counting Co.) to count all of their items and to provide to results to an auditing firm (Audit Firm).

Counting Co. collects the latest block hash from a public blockchain or Audit Firm provides the address. This unique string (A, α) is agreed between XYZ, Audit Firm, & Counting Co. as the “count genesis.” Because the count genesis information is not known before the beginning of the count process, it is certain that no transactions were collected early. Block 602 is generated according to the format:

Aα=f_{#}(α,α,BS,NULL,NULL,NULL)

Counting Co., then creates two block start transactions 604 and 606, one for the east location, and another for the west location. The address of these blocks are provided to Counting Co. staff at their respective locations. These blocks are generated according to the format:

A1=f_{#}(Aα,Aα,BS,“East”,NULL,NULL)

A13=f_{#}(Aα,Aα,BS,“West”,NULL,NULL)

The parent block of block 604, as indicated by arrow 659 is block 602. The prior block of block 604 is block 602 as indicated by arrow 660.

The parent block, as indicated by arrow 680 of block 606 is block 602. The prior block of block 606 as indicated by arrow 681 is block 602.

Counting Co. staff at each location use newly created blocks 604 and 606 to begin the count in the floor stock locations, thereby resulting in blocks 608 and 630 as follows:

A2=f_{#}(A1,A1,BS,“Floor”,NULL,NULL)

A14=f_{#}(A13,A13,BS,“Floor”,NULL,NULL)

The parent block of block 608 as indicated by arrow 662 is block 604. The prior block of block 608 is block 604 as indicated by arrow 663.

The parent block of block 630 is block 606 as indicated by arrow 684. The prior block of block 630 is block 606 as indicated by arrow 683.

Counting Co. staff in the east find 3 zigs and 2 zags in the floor stock location resulting in blocks 610 and 612.

A3=f_{#}(A2,A2,IA,NULL,“Zag”,2)

A6=f_{#}(A2,A3,IA,NULL,“Zig”,3)

The parent block of block 610 is block 608 as indicated by arrow 668. The prior block of block 610 is block 608 as indicated by arrow 669.

The parent block of block 612 is block 608 as indicated by arrow 667. The prior block of block 612 is block 610 as indicated by arrow 670.

Audit Firm wishes to check in on the progress of the count. Counting Co. sends Audit Firm the latest count (3 zigs and 2 zags) along with the most recent block address. Counting Co. also sends all of their most recent transactions back to XYZ in the form of a transaction table, as will be further described.

Counting Co. staff in the east move in counting the back-stock location where they find 1 zig and 2 zags, forming blocks 614, 616 and 618 as follows:

A4=f_{#}(A1,A1,BS,“Back”,NULL,NULL)

A5=f_{#}(A4,A4,IA,NULL,“Zag”,2)

A9=f_{#}(A4,A5,IA,NULL,“Zig”,1)

The parent block of block 614 is block 604 as indicated by arrow 665. The prior block of block 614 is block 604 as indicated by arrow 664.

The parent block of block 616 is block 614 as indicated by arrow 627. The prior block of block 616 is block 614 as indicated by arrow 625.

The parent block of block 618 is block 614 as indicated by arrow 679. The prior block of block 618 is block 616 as indicated by arrow 629.

Counting Co. East staff are finished with this location. They close and join their blocks and transmit the remaining transactions to Counting Co., forming blocks 620, 622, 624, 626 and 628 as follows:

A7=f_{#}(A2,A6,BE,NULL,NULL,NULL)

A8=f_{#}(A7,A7,CJ,NULL,NULL,NULL)

A10=f_{#}(A4,A9,BE,NULL,NULL,NULL)

A11=f_{#}(A10,A8,CJ,NULL,NULL,NULL)

A12=f_{#}(A1,A11,BE,NULL,NULL,NULL)

The parent block of block 620 is block 608 as indicated by arrow 666. The prior block of block 620 is block 612 as indicated by arrow 672.

The parent block of block 622 is block 620 as indicated by arrow 673. The prior block of block 622 is block 620 as indicated by arrow 674.

The parent block of block 624 is block 628 as indicated by arrow 677. The prior block of block 624 is block 622 as indicated by arrow 675.

The parent block of block 626 is block 604 as indicated 661. The prior block of block 626 is block 624 as indicated by arrow 676.

The parent block of block 628 is block 614 as indicated by arrow 678. The prior block of block 628 is block 618 as indicated by arrow 631.

Meanwhile, Counting Co. staff in the west have performed their count. For convenience it is assumed that the same results as East location. They close and join their blocks and transmit to Counting Co., forming blocks 630, 632, 634, 636, 638, 640, 642, 644, 646, 648 and 650, as follows:

A14=f_{#}(A13,A13,BS,“Floor”,NULL,NULL)

A15=f_{#}(A14,A14,IA,NULL,“Zag”,2)

A16=f_{#}(A14,A15,IA,NULL,“Zig”,3)

A17=f_{#}(A14,A16,BE,NULL,NULL,NULL)

A18=f_{#}(A17,A17,CJ,NULL,NULL,NULL)

A19=f_{#}(A13,A18,BS,“Back”,NULL,NULL)

A20=f_{#}(A19,A19,IA,NULL,“Zag”,2)

A21=f#(A19,A20,IA,NULL,“Zig”,1)

A22=f_{#}(A19,A21,BE,NULL,NULL,NULL)

A23=f_{#}(A22,A22,CJ,NULL,NULL,NULL)

A24=f_{#}(A13,A23,BE,NULL,NULL,NULL)

The parent block of block 630 is block 606 as indicated by arrow 684. The prior block of block 630 is block 606 as indicated by arrow 683.

The parent block of block 632 is block 630 as indicated by arrow 688. The prior block of block 632 is block 630 as indicated by arrow 689.

The parent block of block 634 is block 630 as indicated by arrow 687. The prior block of block 634 is block 632 as indicated by arrow 690.

The parent block of block 636 is block 630 as indicated by arrow 686. The prior block of block 636 is block 634 as indicated by arrow 691.

The parent block of block 638 is block 636 as indicated by arrow 692. The prior block of block 638 is block 636 as indicated by arrow 693.

The parent block of block 640 is block 606 as indicated by arrow 685. The prior block of block 640 is block 638 as indicated by arrow 694.

The parent block of block 642 is block 640 as indicated by arrow 697. The prior block of block 642 is block 640 as indicated by arrow 698.

The parent block of block 644 is block 640 as indicated by arrow 696. The prior block of block 644 is block 642 as indicated by arrow 699.

The parent block of block 646 is block 640 as indicated by arrow 695. The prior block of block 646 is block 644 as indicated by arrow 603.

The parent block of block 648 is block 646 as indicated by arrow 605. The prior block of block 648 is block 646 as indicated by arrow 607.

The parent block of block 650 is block 606 as indicated by arrow 615. The prior block of block 650 is block 648 as indicated by arrow 609.

Counting Co. notes the receipt of the block end transactions for each location. Counting Co. traces the transactions received from a to the block end, (as will be further described) confirming count results, and perform the chain joins, resulting in blocks 652, 654 and 656, as follows:

A25=f_{#}(A24,A24,CJ,NULL,NULL,NULL)

A26=f_{#}(A12,A25,CJ,NULL,NULL,NULL)

A27=f_{#}(Aα,A26,BE,NULL,NULL,NULL)

The parent block of block 652 is block 650 is indicated by arrow 613. The prior block of block 652 is block 650 as indicated by arrow 611.

The parent block of block 654 is block 626 as indicated by arrow 651. The prior block of block 654 is block 652 as indicated by arrow 617.

The parent block of block 656 is block 602 as indicated by arrow 682. The prior block of block 656 is block 654 as indicated by arrow 619.

Counting Co. verifies there are no open blocks to indicate ongoing counts and performs a final chain join. Counting Co. provides the ending address (AΩ) to XYZ and to Audit Firm, resulting in block 658, as follows:

AΩ=f_{#}(Aα,A27,CJ,NULL,NULL,NULL)

The parent block of block 658 is block 656 as indicated by arrow 621. The prior block of block 658 is block 656 as indicated by arrow 623.

A transaction table for the preceding example is as follows:

TABLE 1

| Transac- | | | Transac- | | | |
|---|---|---|---|---|---|---|
| tion | Parent | Prior | tion | | | |
| Address | Address | Address | Type | Area | Item | Count |
| A1 | Aα | Aα | BS | “East” | NULL | NULL |
| A2 | A1 | A1 | BS | “Floor” | NULL | NULL |
| A3 | A2 | A2 | IA | NULL | “Zag” | 2 |
| A4 | A1 | A1 | BS | “Back” | NULL | NULL |
| A5 | A4 | A4 | IA | NULL | “Zag” | 2 |
| A6 | A2 | A3 | IA | NULL | “Zig” | 3 |
| A7 | A2 | A6 | BE | NULL | NULL | NULL |
| A8 | A7 | A7 | CJ | NULL | NULL | NULL |
| A9 | A4 | A5 | IA | NULL | “Zig” | 1 |
| A10 | A4 | A9 | BE | NULL | NULL | NULL |
| A11 | A10 | A8 | CJ | NULL | NULL | NULL |
| A12 | A1 | A11 | BE | NULL | NULL | NULL |
| A13 | Aα | Aα | BS | “West” | NULL | NULL |
| A14 | A13 | A13 | BS | “Floor” | NULL | NULL |
| A15 | A14 | A14 | IA | NULL | “Zag” | 2 |
| A16 | A14 | A15 | IA | NULL | “Zig” | 3 |
| A17 | A14 | A16 | BE | NULL | NULL | NULL |
| A18 | A17 | A17 | CJ | NULL | NULL | NULL |
| A19 | A13 | A18 | BS | “Back” | NULL | NULL |
| A20 | A19 | A19 | IA | NULL | “Zag” | 2 |
| A21 | A19 | A20 | IA | NULL | “Zig” | 1 |
| A22 | A19 | A21 | BE | NULL | NULL | NULL |
| A23 | A22 | A22 | CJ | NULL | NULL | NULL |
| A24 | A13 | A23 | BE | NULL | NULL | NULL |
| A25 | A24 | A24 | CJ | NULL | NULL | NULL |
| A26 | A12 | A25 | CJ | NULL | NULL | NULL |
| A27 | Aα | A26 | BE | NULL | NULL | NULL |

Counting Co. provides the transaction table and the hash function to Audit Firm and XYZ. The transaction table may be used to verify the count.

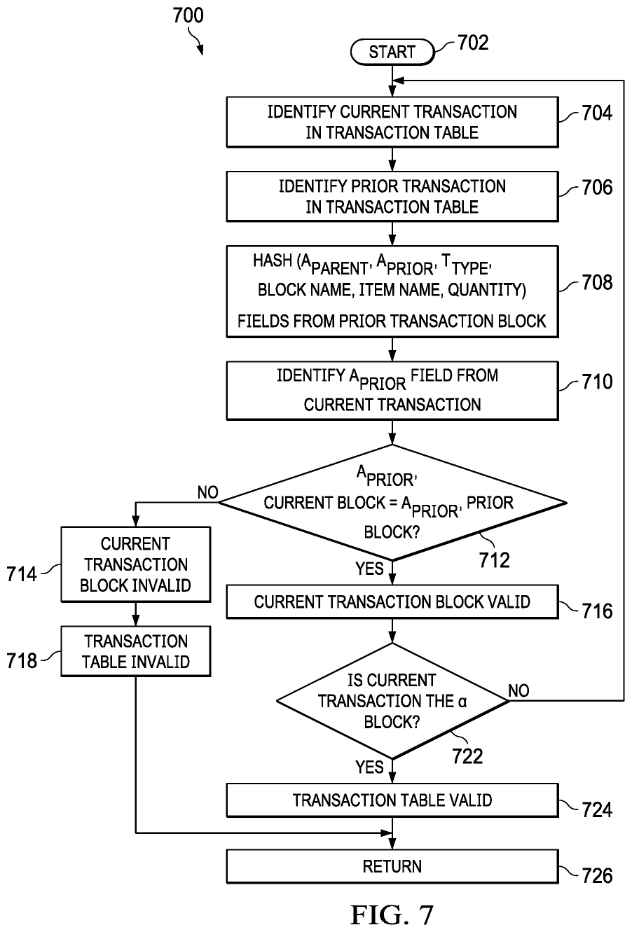

Referring to FIG. 7, process 700 of validating the transaction table will be described.

As previously discussed, each transaction address is the hash of its contents. These contents include its prior and parent transaction addresses. When a transaction table is verified, the address contained in one transaction is used to “lookup” the corresponding parent or prior transaction address. If the hash value of the transaction matches the address of the current transaction, then the current transaction is unaltered and so is valid.

The transaction table is only valid if the addresses can be traced from the Ω block to the α block with an addresses valid.

For example, valid CJ transactions must have a valid BE transaction as parent and have valid BE or CJ as prior transaction.

Valid Block End (BE) transactions must have a valid block start (BS) as parent transaction and have a traceable prior transaction path to their parent block start (BS) transaction.

Valid Block Start (BS) transactions must have a valid block start (BS) or Alpha block as parent transaction and have a traceable prior transaction path to their parent block start (BS) transaction.

Valid Item Add (IA) transactions must have a valid block start (BS) as parent transaction and have a traceable prior transaction path to their parent block start (BS) transaction.

At step 702, the method begins. At step 704, the current transaction in the transaction table is identified. For example, and in most cases, the current transaction chosen is the Ω block.

At step 706, the transaction prior to the current transaction is identified in the transaction table.

At step 708, the hash function is applied to the Aₚₐᵣₑₙₜ, Aₚᵣᵢₒᵣ, T_{type}, block name, item name, and quantity fields from the prior transaction block in the transaction table. If the hash function is a rotating hash, then the predetermined hash order is reversed to determine which hash function to use to decode the prior transaction.

At step 710, the Aₚᵣᵢₒᵣ field is identified from the current transaction in the transaction table.

At step 712, the Aₚᵣᵢₒᵣ value from the current block is compared to the Aₚᵣᵢₒᵣ value from the prior block. If the addresses match, then the method moves to step 716. If the addresses do not match, then the method moves to step 714.

At step 716, the current transaction block is identified as valid and the method moves to step 722. At step 722, a decision is made whether or not the current transaction being validated is the Alpha block. If not, the method returns to step 704 where a new current transaction is identified. If so, the method moves to step 724. At step 724, the transaction table is validated. At step 726, the method returns.

At step 714, the current transaction block is set as invalid. At step 718, the transaction table is declared invalid. The method then returns at step 726.

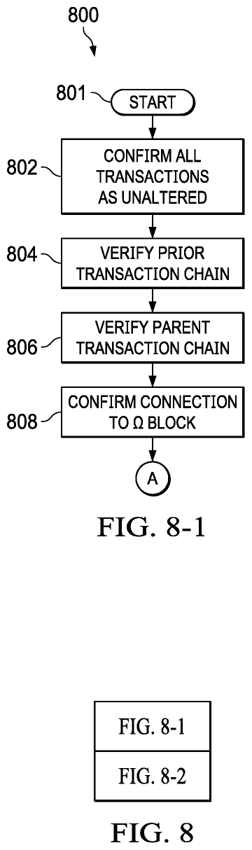

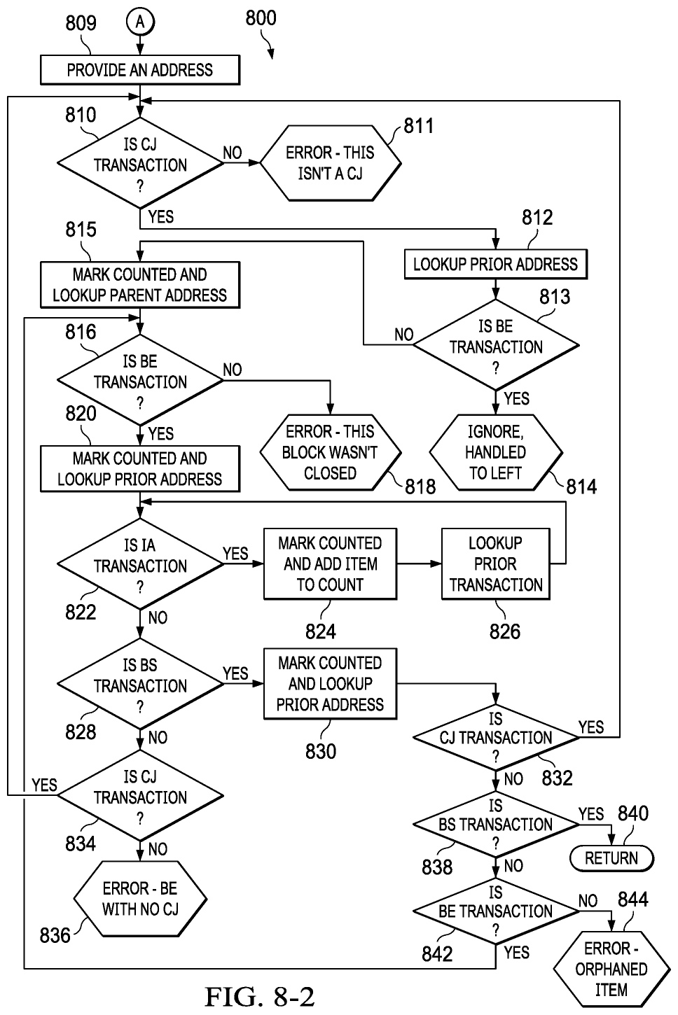

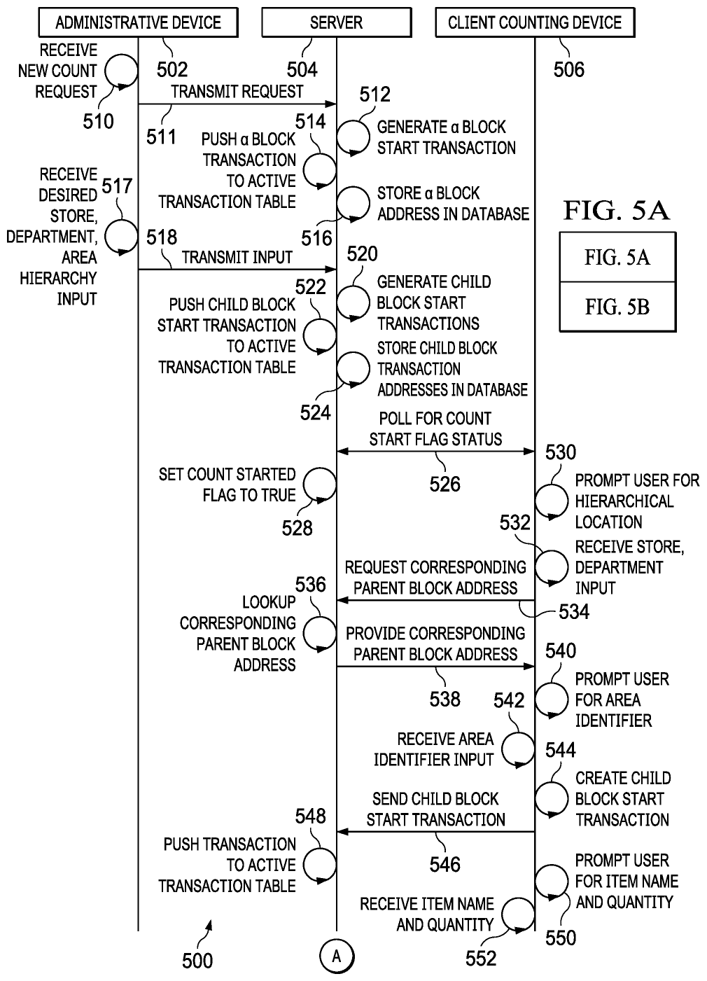

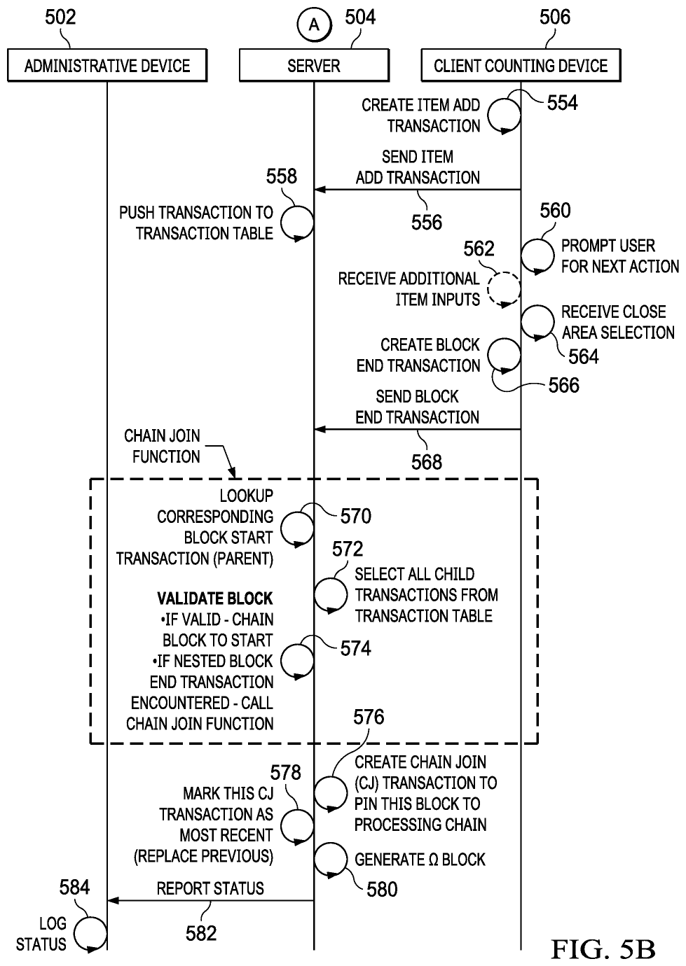

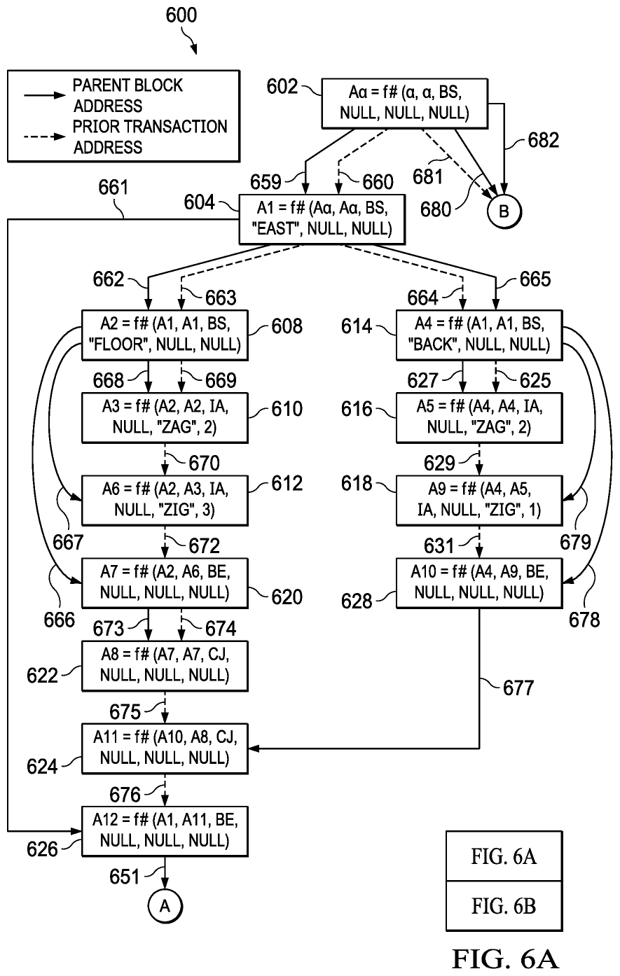

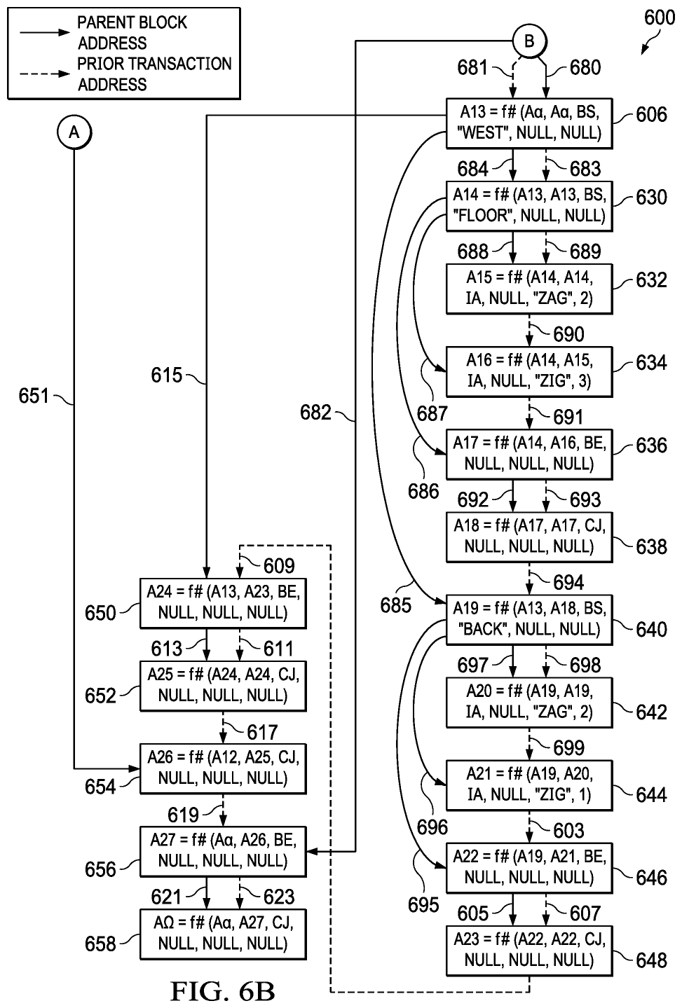

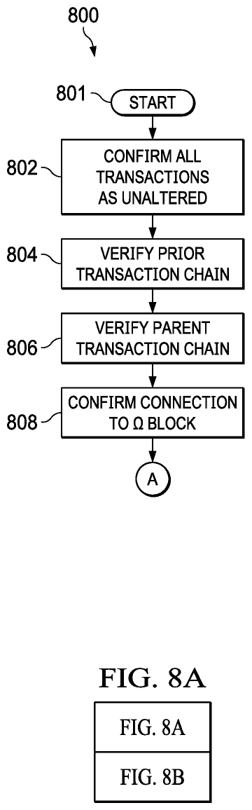

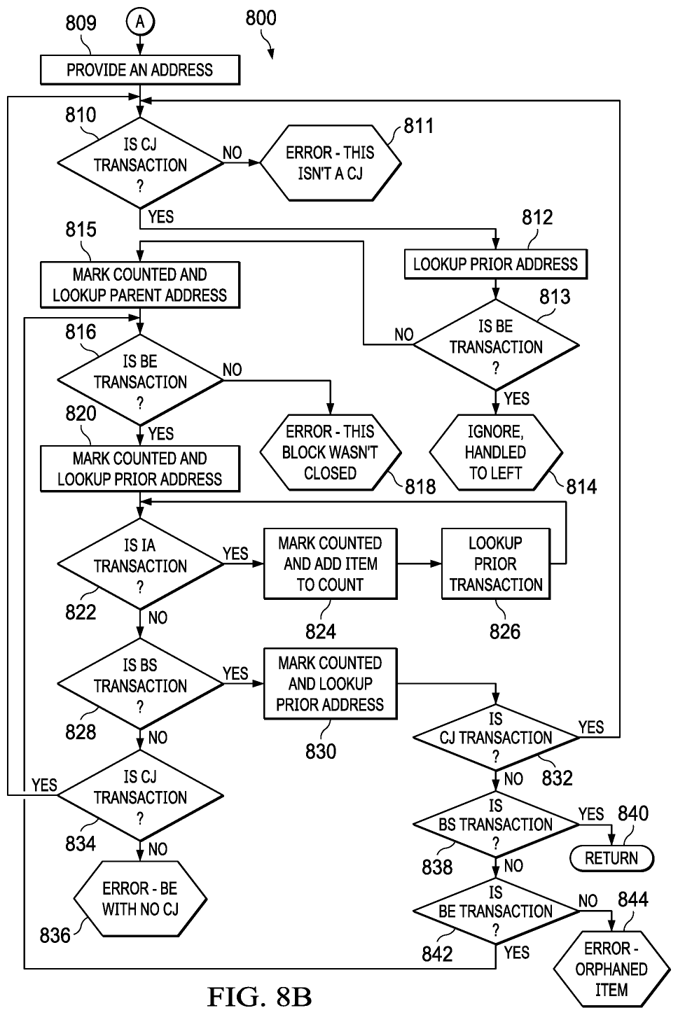

Referring to FIGS. 8A and 8B, an alternate method 800 of validating a transaction table will be described as method 800.

Referring then to FIG. 8A, at step 801, the method begins.

At step 802, all transactions must be confirmed as unaltered by comparing each transaction address to the SHA256 hash of its payload, according to the following steps:

For each transaction in transaction table

If transaction address is equal to hash of transaction

Mark the transaction hash as correct

Else:

Mark the transaction as hash incorrect

If any of the transactions fail to pass the hash check, then it is concluded that they have been tampered with or corrupted and are dropped from the transaction table.

At step 804, it must be verified whether or not each transaction has a valid prior transaction chain to the α block, according to the following steps:

For each transaction in the transaction table {

do while ( this transaction address is not equal to the alpha seed ) {

select prior transaction address from the transaction table

where transaction address == this transaction address

if prior transaction address cannot be found in the table

mark this transaction as prior trace failed

if prior transaction address is alpha seed

mark this transaction as prior trace passed

#otherwise, we haven't found the end yet, keep going
This transaction address = prior transaction address

}

}

If any of the transactions fail to pass, then they are not part of the valid count chain and are dropped from the transaction table.

At step 806, it must be verified that each transaction has a valid parent transaction chain back to the α block according to the following steps:

For each transaction in the transaction table {

do while (this transaction address is not equal to the alpha seed) {

select parent transaction address from the transaction table

where transaction address == this transaction address

if the parent transaction address does not exist in the table

mark the transaction as prior trace failed

if parent transaction address is alpha seed

mark this transaction as prior trace flag passed

#otherwise, we haven't found the end yet, keep going
This transaction Address = parent transaction address

}

}

If any transaction fails to be connected to a valid parent chain to the α block, they are dropped from the transaction table.

All transactions are now traceable to the α block along their prior and parent paths.

At step 808, it must be confirmed that the transactions are connected to the Ω block by ensuring they are included in a chain which is chain joined to the Ω block, if they are, any items in the chain may be counted.

Referring then to FIG. 8B, at step 809, the user provides an address of a block in the transaction chain. At step 810, the block is examined to determine whether or not it is a CJ transaction. If not, the method moves to step 811. If so, the method moves to step 812. At step 811, an error is declared and the process ends.

At step 812 the process looks up the prior block address. At step 813, the process decides whether or not the block at the prior address is a BE transaction. If so, the method moves to step 814 and ignores the transaction. If not, the method moves to step 815.

At step 815, the method marks the block as counted and looks up the parent address. At step 816, the process decides whether or not the block at the parent address is a BE transaction. If not, the method moves to step 818 and concludes. If so, the method moves to step 820.

At step 820, the block is marked as counted and the method looks up the block with the prior address.

At step 822, the method decides whether or not this block is IA transaction. If so, the method moves to step 824. If not, the method moves to step 828. At step 824, the block is marked as counted and the items are added to the inventory count. At step 826, the method looks up the prior transaction block and returns to step 822.

At step 828, the process decides whether or not the transaction block is a BS transaction. If so, the method moves to step 830. If not, the method moves to step 834. At step 834, the process decides whether or not it is a CJ transaction. If so, the method returns to step 810. If not, the method moves to step 836 and an error is produced.

At step 830, the process marks the block as counted and looks up the address of the prior block.

At step 832, the process decides whether or not the prior block is a CJ transaction or not. If so, the method returns to step 810. If not, the method moves to step 838.

At step 838, the process decides whether or not the current block is a BS transaction. If so, the method moves to step 840 and returns. If not, the method moves to step 842.

At step 842, the method decides whether or not the block is a BE transaction. If not, the method moves to step 844 and concludes. If so, the method returns to step 816.

1. A method of creating a cryptographically secure chain of inventory count data comprising:
creating an alpha block transaction address by applying a first hash function of a seed value;
creating a block start transaction address by applying a second hash function of the alpha block transaction address;
creating an item add transaction address by applying a third hash function of the block start transaction address;
creating a block end transaction address by applying a fourth hash function of the item add transaction address; and,
creating an omega block transaction address by applying a fifth hash function of the block end address.

2. The method of claim 1 wherein the seed value is time dependent.

3. The method of claim 1 wherein the first hash function, second hash function, third hash function, fourth hash function and fifth hash function are a singular hash function.

4. The method of claim 3 wherein the singular hash function is one of the group of SHA256, MD5, RIPEMD256, WHIRLPOOL, TIGER(192), and GOST(256).

5. The method of claim 1 wherein the first hash function, second hash function, third hash function, fourth hash function and fifth hash function are a rotating set of hash functions.

6. The method of claim 1 wherein the step of creating the alpha block transaction address further comprises:
applying the first hash function to a parent block address, a prior block address, a block start transaction type and a count start parameter.

7. The method of claim 1 wherein the step of creating the block start transaction address further comprises:
applying the second hash function to the alpha block transaction address, a block start transaction type and a store identifier.

8. The method of claim 1 wherein the step of creating the block start transaction address further comprises:
applying the second hash function to the alpha block transaction address, a block start transaction type and an area identifier.

9. The method of claim 1 wherein the step of creating the item add transaction address further comprises:
applying the third hash function to the alpha block transaction address, the block start transaction address, an item add transaction type, an item identifier and a count identifier.

10. The method of claim 1 wherein the step of creating the block end transaction address further comprises:
applying the fourth hash function to the alpha block transaction address, the item add transaction address and a block end transaction type.

11. The method of claim 1 wherein the step of creating the omega block transaction address further comprises:
applying the fifth hash function to the seed value, the block end transaction address and a chain join transaction type.

12. A method of creating a cryptographically secure chain of inventory count data comprising:
creating an alpha block transaction;
creating a block start transaction;
determining whether or not a number of stores is greater than one;
if the number of stores is not greater than one, then determining whether or not a number of areas is greater than one;
if the number of areas is not greater than one, then creating a block start transaction for a first store and a first area;
creating a first item add transaction related to the inventory count data;
creating a first block end transaction; and,
creating an omega block chain join transaction.

13. The method of claim 12 further comprising:
if the number of stores is greater than one, then creating a block start transaction for a second store;
creating a second item add transaction related to the inventory count data;
creating a second block end transaction;
creating a block chain join transaction; and,
joining the block chain join transaction to the first block end transaction.

14. The method of claim 13 further comprising:
if the number of areas is greater than one, then creating a block start transaction for the first store and a second area;
creating a second item add transaction related to the inventory count data;
creating a second block end transaction;
creating a block chain join transaction; and,
joining the block chain join transaction to the first block end transaction.

15. A method of validating a transaction table comprising:
identifying a current transaction in the transaction table;
identifying a prior transaction in the transaction table;
hashing a set of parameters from the prior transaction to determine a first transaction address;
identifying a second transaction address from the current transaction;
comparing the first transaction address to the second transaction address to arrive at a match condition;
declaring the current transaction invalid and the transaction table invalid if the match condition is false; and,
declaring the current transaction valid if the match condition is true and the current transaction is an alpha transaction block.

16. The method of claim 15 wherein the step of hashing a set of parameters further comprises hashing at least one of the group of a parent block address, a prior block address, a block name, an item name and a quantity.

17. The method of claim 15 wherein the step of hashing a set of parameters further comprises applying one cypher from the group of SHA256, MD5, RIPEMD256, WHIRLPOOL, TIGER(192) and GOST(256).

18. A system for creating a cryptographically secure chain of inventory count data comprising:
a server, having a first memory, connected to a network;
a client counting device, having a second memory, connected to the server through the network;
a set of program instructions, resident in the first memory and the second memory that when executed cause the system to carry out the steps of:
creating an alpha block transaction address from a first hash of a seed value;
creating a block start transaction address from a second hash of the alpha block transaction address;
creating an item add transaction address from a third hash of the block start transaction address;
creating a block end transaction address from a fourth hash the item add transaction address; and,
creating an omega block transaction address from a fifth hash of the block end address.

19. The method of claim 18 wherein the first hash, second hash, third hash, fourth hash and fifth hash are a singular hash function.

20. The method of claim 19 wherein the singular hash function is one of the group of SHA256, MD5, RIPEMD256, WHIRLPOOL, TIGER(192) and GOST(256).
